(19) United States
(12) Patent Application Publication
(10) Pub. No.: US 2025/0328028 A1
(43) Pub. Date: Oct. 23, 2025

(54) Eyewear with Multi-Pronged Earstem Tool

(71) Applicant: Dart Golf LLC, Mission, KS (US)

(72) Inventor: David Petersen, Wichita, KS (US)

(73) Assignee: Dart Golf LLC, Mission, KS (US)

(21) Appl. No.: 18/643,470

(22) Filed: Apr. 23, 2024

(51) Int. Cl. G02C 5/14; A63B 57/50; G02C 5/00; G02C 5/20

(52) U.S. Cl. CPC G02C 5/143; G02C 5/001; G02C 5/20; A63B 57/50

(57) ABSTRACT

An eyewear's earstem is provided with a unique design and function. A functional earstem may comprise a specialized tool with an end that is forked into a plurality of prongs. The prongs of the earstem tool may be utilized for repairing divots made on a golfing green. Other configurations of the earstem tool may provide convenient and adaptable solutions to tasks at hand.

### CROSS REFERENCES

Not Applicable.

### REFERENCE TO RESEARCH

Not Applicable.

### REFERENCE TO CDS

Not Applicable.

### FIELD OF THE INVENTION

The present disclosure relates generally to eyewear, and more particularly, to earstems of eyewear.

### BACKGROUND

Eyewear generally includes a frame connected to earstems that may accommodate different head sizes and shapes. Improvements have focused on providing earstems that secure the eyewear to the wearer's head. Earstems may incorporate hinges or flexible materials to enhance the comfort and fit of the earstems. Different earstem styles or lengths may be connected to the eyewear frame to allow users of these designs some level of customization and personalization. Eyewear generally include lenses adapted to environments having different lighting. Users of eyewear, such as golfers, may utilize sunglasses in environments having greater amounts of sunlight. Many golfers are equipped with other accessories such as divot repair tools. Golfers deploy them in the application of divot repairs on golfing greens.

### SUMMARY

In general, this disclosure relates to eyewear having: (a) an earstem including: (i) an earstem tool that is forked into a plurality of prongs.

In some aspects, the examples described in this disclosure relate to eyewear, where the plurality of prongs extend parallel with a longitudinal axis of the earstem.

In some aspects, the examples described in this disclosure relate to eyewear, where the earstem tool includes at least three prongs.

In some aspects, the examples described in this disclosure relate to eyewear having: (a) a retention member mounted on the earstem that is structured to release the earstem tool from the earstem.

In some aspects, the examples described in this disclosure relate to eyewear having: (a) an aperture within the earstem into which at least a portion of the earstem tool is removably inserted.

In some aspects, the examples described in this disclosure relate to eyewear having: (a) a retention member mounted to the earstem that is structured to hold the portion of the earstem tool inserted into the earstem.

In some aspects, the examples described in this disclosure relate to eyewear, where at least a portion of the earstem surrounds the earstem tool inserted into the aperture.

In some aspects, the examples described in this disclosure relate to eyewear having: (a) a retention member mounted to the earstem that is structured to retain the earstem tool upon the earstem.

In some aspects, the examples described in this disclosure relate to eyewear, where the earstem may include an earstem tool that is interchangeable.

In some aspects, the examples described in this disclosure relate to eyewear, where the earstem tool is structured to retract and extend within the earstem.

In some aspects, the examples described in this disclosure relate to eyewear having: (a) an aperture within the earstem tool into which at least a portion of the earstem is removably inserted.

In some aspects, the examples described in this disclosure relate to eyewear having: (a) a retention member mounted to a frame of the eyewear that is structured to retain the earstem upon the frame.

In some aspects, the examples described in this disclosure relate to eyewear, where at least a portion of the earstem tool surrounds the earstem inserted into the aperture.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 depicts a front perspective view showing an example design of the disclosed eyewear with earstem tool.

FIG. 2 depicts a front elevational view of eyewear shown in FIG. 1.

FIG. 3 depicts a rear elevational view of eyewear shown in FIG. 1.

FIG. 4 depicts a left-side elevational view of eyewear shown in FIG. 1.

FIG. 5 depicts a top plan view of the eyewear shown in FIG. 1.

FIG. 6 depicts a bottom plan view of eyewear shown in FIG. 1.

FIG. 7 depicts a right-side elevational view showing an example design of an earstem having an earstem tool.

FIG. 8 depicts a right-side elevational view showing another example design of an earstem having an earstem tool.

FIG. 9 depicts a side elevational view showing an earstem tool retracted within an earstem.

FIG. 10 depicts a side elevational view of the earstem of FIG. 9 showing the earstem tool exposed.

### DETAILED DESCRIPTION

The present disclosure introduces a unique earstem configuration that offers increased functionality over previous eyewear designs. The functionality of the earstem is increased by providing an earstem tool. In particular, examples in this disclosure relate to an earstem tool for golfers. The earstem tool may function to repair a mark made on a golfing green, also known as a “divot”. The earstem tool may be structured with a plurality of prongs extending from an end of the earstem. The plurality of prongs may be removably inserted into an aperture disposed within the earstem and held in place by a retention member. The retention member may directly engage the structure of the earstem or frame of the eyewear. The retention member may be detachably coupled to the eyewear for release of the earstem tool from the eyewear. The interchangeability of the earstem tool may provide varied functional uses.

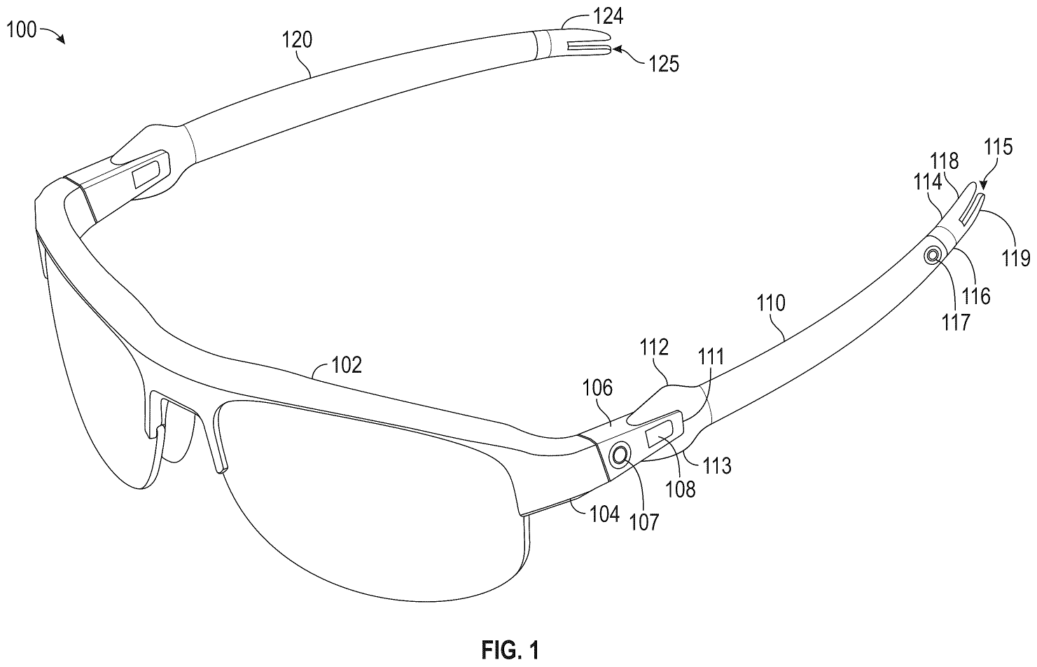

FIG. 1 depicts a front perspective view showing an example design of the eyewear 100 having an earstem tool. The eyewear 100 comprises a pair of earstems. Each earstem 110, 120 is attached to a frame 102 of the eyewear 100. Each earstem 110, 120 may comprise an earstem tool 114, 124. The earstem tool 114, 124 may be forked, having a divided or pronged end. As shown, the forked end of the earstem tool 114, 124 is forked into a plurality of prongs 115, 125. In some cases, the earstem tool 114, 124 may be bifurcated having two prongs that terminate at the earstem tip. In other cases, the earstem tool 114, 124 may comprise at least three prongs.

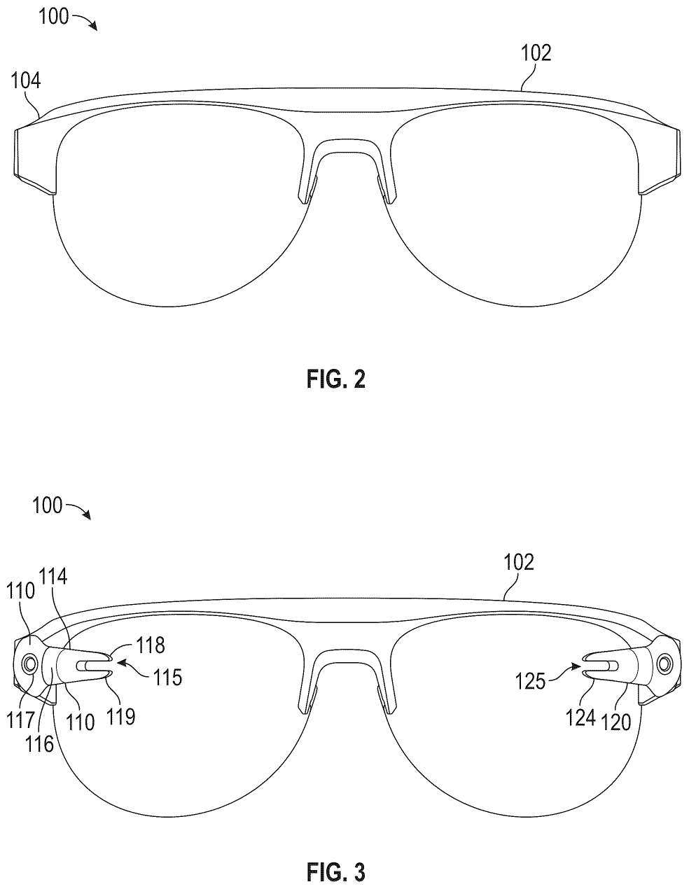

FIG. 2 depicts a front elevational view of eyewear 100 shown in FIG. 1. The eyewear 100 comprises an end piece 104. The end piece 104 may be integrally formed with frame 102. Referring back to FIG. 1, a retention member 106 is shown mounted to the end piece 104 of frame 102. Retention member 106 may be disposed in an operative position along the length of the earstem 110. In this example, the retention member 106 can be integrated into an anterior end of the earstem 110. The anterior end of the earstem 110 may be disposed proximally towards the frame 102. Retention member 106 is structured to retain the earstem 110 upon frame 102. Retention member 106 may comprise one or more latch members, retention tabs, cavities, clips, apertures, protrusions, or detents configured to be coupled with, for receiving and holding, or being supported upon, a complementary portion of the frame 102. Engagement portion(s) of the frame 102, likewise, may comprise one or more hinge pins, recesses, protrusions, detents, apertures, or other engagement structures that can be coupled with the retention member 106 of the earstem 110 to produce an interference fit.

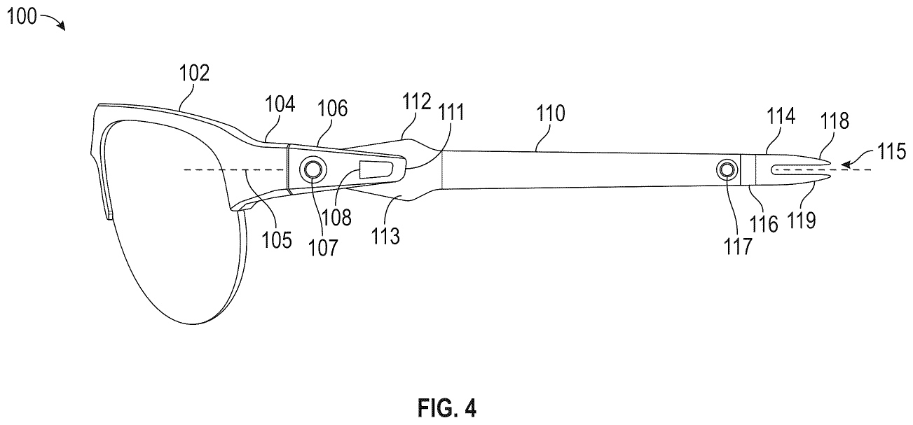

FIG. 3 depicts a rear elevational view of eyewear 100 shown in FIG. 1. Each earstem 110, 120 curves inward towards the medial plane of the eyewear 100. The earstem tool 114 may be U-shaped being bifurcated into a first prong 118 and a second prong 119. The first prong 118 extends adjacently parallel with the second prong 119 away from the longitudinal body of the earstem 110. The plurality of prongs 115 may extend parallel with a longitudinal axis 105 of the earstem's longitudinal body, which is best shown in FIG. 4. The first prong 118 and the second prong 119 may point in the same direction and be the same distance apart along the length of each prong. A slot between the first prong 118 and the second prong 119 may have a constant width or be narrower at one end of the separate prongs. For example, the slot may have a narrower width at an anterior end of the slot that increases in width towards a posterior end of the slot between the tips of the plurality of prongs 115 at the end of the earstem 110.

FIG. 4 depicts a left-side elevational view of eyewear 100 shown in FIG. 1. The right-side elevational view is not shown but in this case would be a mirror image of the eyewear 100 shown in FIG. 4. As shown in FIG. 4, retention member 106 may comprise a detent mechanism 107 structured to engage with the end piece 104 of frame 102. The detent mechanism 107 may be a button, catch, latch, pin, detachable connection, or combination of the aforementioned detent mechanisms, that may be pushed, pulled, pivoted, snapped, or slid to attach and detach the earstem 110 from the frame 102 of the eyewear 100.

In some examples, the detent mechanism 107 may be a pressable button, knob, tab, snap, slide mechanism, or other coupling structure disposed on an anterior end of the earstem 110. The wearer of eyewear 100 may press the detent mechanism 107 and release the earstem 110 from the frame 102 of eyewear 100. The earstem 110 may be held in the hand of the wearer. The earstem 110 may be of a length and size that accommodates the width of a hand of the wearer. In addition, the earstem 110 may be shaped and sized to comfortably fit the temple and ears of the wearer. For example, golfer wearing the eyewear 100 as sunglasses have the dual capability of utilizing the earstem 110 with the earstem tool 114 to repair a divot during play.

In other examples, as detailed more fully later in this disclosure, a detent mechanism 117 may be disposed on a posterior end of the earstem 110. The wearer of the eyewear 100 may press the detent mechanism 117 and release the earstem tool 114 from the earstem 110 of eyewear 100. The earstem tool 114 may be held in the hand of the wearer when utilizing the earstem tool 114. The earstem tool 114, designed for any particular task at hand, may be utilized whether the retention member is in an attached configuration with the eyewear 100 or in a detached configuration with the eyewear 100.

As best shown in FIG. 4, the earstem tool 114 is structured as a divot repair tool for the repair of divots made in a golfing green by a golfer. The earstem tool 114 is forked into a plurality of prongs 115 that terminate at the earstem tip at the posterior end of the earstem 110. The plurality of prongs 115 comprise at least a first prong 118 and a second prong 119. The first prong 118 and the second prong 119 may be disposed parallel and adjacent with a longitudinal axis 105 of the earstem 110. Alternatively, the first prong 118 and the second prong 119 may be disposed at an angle of between zero degrees and 45 degrees from the longitudinal axis 105. In some cases, the first prong 118 and the second prong 119 may be straight, for example, not being angled more than one to five degrees from the longitudinal axis 105.

The earstem 110 comprising the earstem tool 114 may be interchangeable. In some cases, the anterior end of earstem 110 may connect detachably to retention member 106. The anterior end of the earstem 110 may engage with the detent mechanism 107 disposed on retention member 106. The detent mechanism 107 may be disposed on the end piece 104 of frame 102. The anterior end of the earstem 110 may be structured to cooperate operably with the detent mechanism 107 for attachment and detachment of the earstem 110 from the frame 102 of the eyewear 100. In these examples, the earstem 110 comprising the earstem tool 114 may be interchangeable with another earstem having different earstem tools. Alternatively, the earstem 110 may be interchangeable with earstems used in everyday wear.

Now referring to the anterior end of earstem 110 as shown in FIG. 4. The anterior end of earstem 110 may have an upper portion 112 and a lower portion 113. The upper portion 112 and the lower portion 113 may be angled. The upper portion 112 and the lower portion 113 may taper towards an engagement point disposed at the anterior end of the earstem 110. The engagement point may engage with the detent mechanism 107 disposed in an anterior end of the retention member 106. Cooperative engagement between the engagement point and the detent mechanism 107 may function to retain and support the earstem 110 with the retention member 106.

The retention member 106 may have an aperture that is complementary shaped with a protrusion 108 disposed on an anterior face of the earstem 110. Protrusion 108 may be received by the aperture. Protrusion 108 may interlock within the earstem end 111 of retention member 106. The earstem end 111 of retention member 106 may encircle the protrusion 108. The interlock formed between protrusion 108 and retention member 106 may function to retain and support the earstem 110 in an attached configuration with frame 102. The earstem end 111 of retention member 106 may be lifted outwards away from the protrusion 108. Release of the retention member 106 from the anterior end of the earstem 110 may occur during engagement of the detent mechanism 107. As mentioned previously, the detent mechanism 107 may be any number of coupling structures. Engagement of the detent mechanism 107 may allow the earstem 110 to be released into the detached configuration with frame 102. In some cases, the anterior end of earstem 110 may connect pivotably to retention member 106. In other cases, retention member 106 may connect pivotably with end piece 104 of frame 102. The pivotable connection may comprise a rotatable socket or hinge pin for coupling engagement.

Now referring to the posterior end of earstem 110 as shown in FIG. 4. A retention member 116 may be mounted on the posterior end of earstem 110. Retention member 116 may be disposed adjacent to earstem tool 114. An aperture may be disposed within retention member 116 at the posterior end of earstem 110. A portion of earstem tool 114 may be removably inserted into the aperture.

An aperture may be structured to hold the portion of the earstem tool 114 inserted into the earstem 110. A portion of the earstem 110 may circumferentially surround the earstem tool 114 that is inserted into the aperture. Earstem tool 114 may comprise a shank having a smaller diameter than the earstem 110. The shank's diameter may be complementary in shape and size with the aperture. Alternatively, a retention member 116 may be structured to hold the portion of the earstem inserted into the aperture. Retention of the earstem tool 114 in an attached configuration with eyewear 100 may be due to the shank being complementary in size and shape with the retention member 116. Retention member 116 may comprise an aperture that receives a base of the earstem tool 114.

Retention member 106 may be structured to release the earstem tool 114 from the earstem 110. Retention member 116 may comprise a detent mechanism 117. Earstem tool 114 may be released from retention member 116 by engagement of detent mechanism 117. Detent mechanism 117 may be a pressable button, knob, tab, snap, slide mechanism, or other coupling structure. The detent mechanism may hold the shank of earstem tool 114 in the attached configuration of eyewear 100.

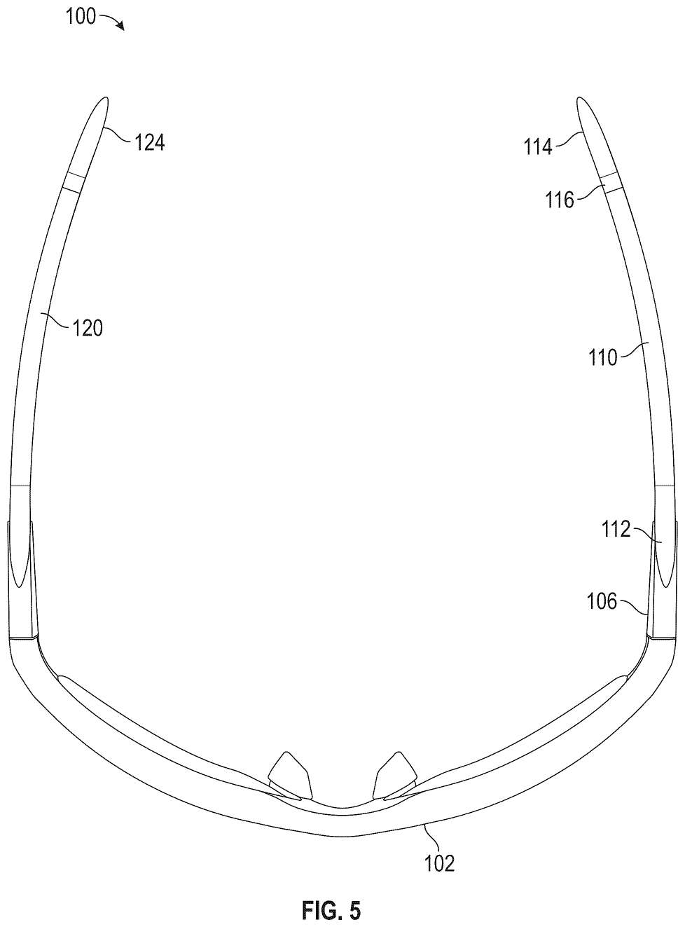

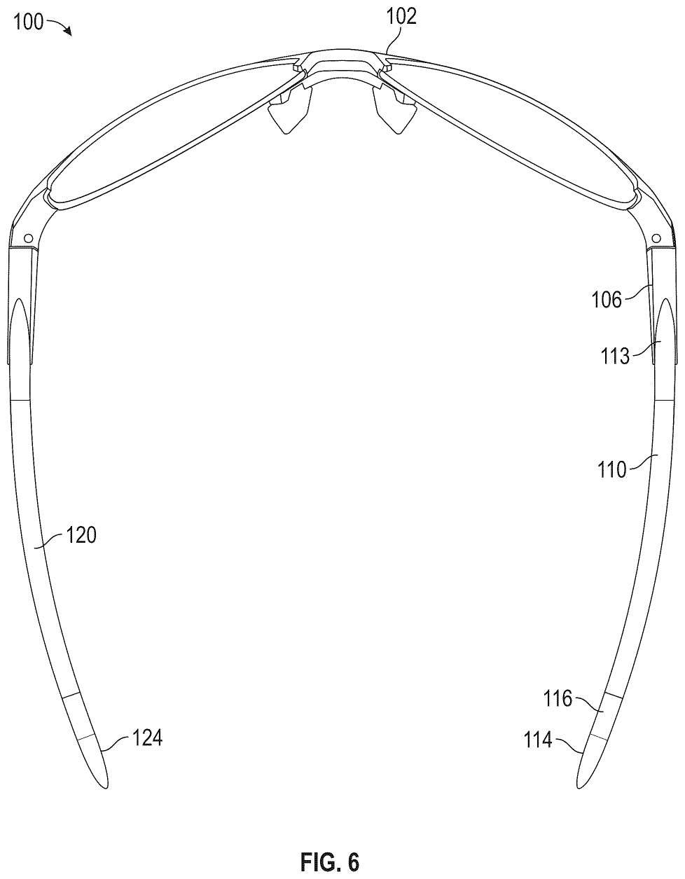

FIG. 5 depicts a top plan view of the eyewear 100 shown in FIG. 1. FIG. 6 depicts a bottom plan view of eyewear 100 shown in FIG. 1. Each earstem 110, 120, having an earstem tool 114, 124, may be angled or curved. As shown, the posterior ends of earstem 110, 120 curve inwardly towards the medial plane of eyewear 100. Alternatively, the earstem 110, 120 may be substantially straight, not curving inwards more than about zero degrees to five degrees.

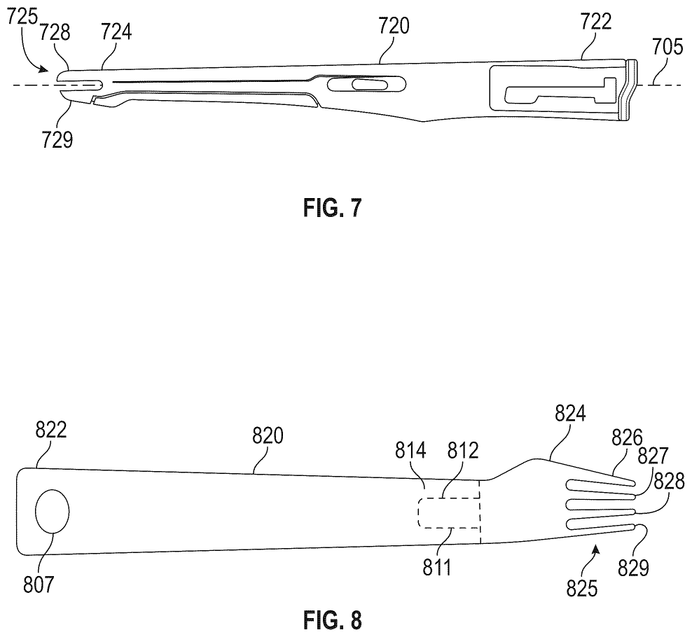

FIG. 7 depicts a right-side elevational view showing an example design of an earstem 720 having an earstem tool 724. Earstem 720 has a longitudinal body that extends lengthwise, both left and right, between the earstem tool 724 disposed on a posterior end of the earstem 720 and a retention member 722 disposed on an anterior end of the earstem 720.

The retention member 722 may be detachably coupled to the eyewear for release of the earstem 720 from the eyewear. Being detachably coupled allows the earstem 720 to be interchangeable as well as providing the wearer of the eyewear the capability to utilize the earstem as a handheld tool. The retention member 722 may be structured to be mounted directly to a frame of the eyewear for retention of earstem 720.

The retention member 722 may comprise one or more latch members, retention tabs, cavities, apertures, protrusions, or detents configured to be coupled with, for receiving and being supported upon, a complementary portion of the frame. Engagement portion(s) of the frame, likewise, may comprise one or more complementary hinge pins, recesses, protrusions, detents, apertures, or other engagement structures that can be coupled with retention member 722 to produce an interference fit.

As shown in FIG. 7, the posterior end of the earstem 720 has an earstem tool 724. The earstem tool 724 may be bifurcated. The earstem tool 724 may be U-shaped having a first prong 728 that is adjacent with a second prong 729. The first prong 728 and second prong 729 extend distally away from the longitudinal body of the earstem 720. The first prong 728 and second prong 729 may be parallel with a longitudinal axis 705 of the earstem's longitudinal body.

A slot disposed between the first prong 728 and the second prong 729 may have a constant width or be narrower at one end of the slot. In the example shown, the slot has a constant width along the slot's length between the first prong 728 and the second prong 729. The tips of the first prong 728 and the second prong 729 may be curved along an outside edge until termination with the slot. The curved edges of the first prong 728 and the second prong 729 may prevent the wearer of the eyewear 100 from being skewered by the plurality of prongs 725 while putting on the eyewear 100.

FIG. 8 depicts a right-side elevational view showing another example design of an earstem 820 having an earstem tool 824. Earstem 820 has a longitudinal body that extends lengthwise, both left and right, between the earstem tool 824 disposed on a posterior end of the earstem 820 and a retention member 822 disposed on an anterior end of the earstem 820.

The retention member 822 may be detachably coupled to the eyewear for release of the earstem 820 from the eyewear. Being detachably coupled allows the earstem 820 to be interchangeable as well as providing the wearer of the eyewear the capability to utilize the earstem as a handheld tool. The retention member 822 may be structured to be mounted directly to a frame of the eyewear for retention of earstem 820.

The retention member 822 may comprise one or more latch members, retention tabs, cavities, apertures, protrusions, or detents configured to be coupled with, for receiving and being supported upon, a complementary portion of the frame. Engagement portion(s) of the frame, likewise, may comprise one or more hinge pins, recesses, protrusions, detents, apertures, or other engagement structures that can be coupled with retention member 822 of earstem 820 to produce an interference fit. In the example shown, a detent mechanism 807 is disposed within the retention member 822 to releasably attach the earstem 820 with the eyewear frame.

As shown in FIG. 8, the posterior end of earstem 820 has an earstem tool 824. The earstem tool 824 may be forked into a plurality of prongs 825. The earstem tool 824 may be forked into at least three prongs. In the example shown, there are four prongs. The earstem tool 824 comprises a first prong 826, a second prong 827, a third prong 828, and a fourth prong 829. The plurality of prongs 825 together with the earstem tool 824 may be fork-shaped.

In the provided examples, the plurality of prongs 825 may be utilized as a divot repair tool. The earstem tool 824 may repair a divot by forcing turf in a generally horizontal direction, from an edge of the divot toward a center of the divot, using a generally vertical motion applied to the longitudinal body of the earstem 820. In some cases, the earstem tool 824 when inserted into the ground is configured to permit the user to leverage the longitudinal body of the earstem 820 towards or away from the ground.

In other cases, the user may remove the earstem tool 824 from the earstem 820 to repair a divot. The earstem tool 824 shown in FIG. 4 comprises a shank 812 having a smaller diameter than the earstem 820. The shank's diameter may be complementary in shape and size with an aperture 811 disposed in the posterior end of earstem 820. The earstem tool 824 may be retained in an attached configuration with eyewear where a portion 814 of the earstem 820 surrounds shank 812 inserted into the aperture 811. The user may pull outwards on the earstem tool 824, distally away from the earstem 820, to remove and use the earstem tool 824.

Alternatively, the posterior end of earstem 820 may have a smaller diameter than an aperture disposed within earstem tool 824. In an attached configuration with eyewear, the earstem tool 824 surrounds the posterior end of the earstem 820 inserted into the aperture. In the detached configuration with eyewear, the portion of the earstem 820 inserted into the aperture of the earstem tool 824 is removed from the aperture and the user applies the earstem tool 824 individually to the task at hand without holding the earstem 820.

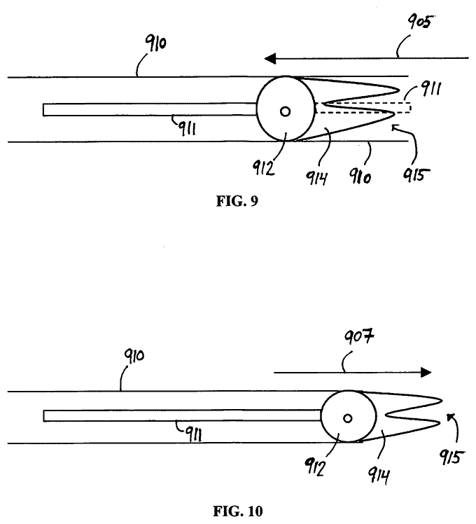

FIG. 9 depicts a side elevational view showing an earstem tool 914 retracted within an earstem 910. The earstem 910 may comprise a hollow chamber or cavity for the earstem tool 914 to be drawn back into and housed when retracted. A sliding member 912 may be connected with the earstem tool 914. The sliding member 912 may be structured to slide within a sliding aperture 911 disposed in a sidewall of the earstem 910. In the example shown, the earstem tool 914 has been retracted by the sliding member 912 along movement arrow 905 so that the plurality of prongs 915 are housed within the chamber of earstem 910. In the retracted configuration, the eyewear may be worn by the wearer without exposure of the plurality of prongs 915.

FIG. 10 depicts a side elevational view of FIG. 9 showing the earstem tool 914 exposed beyond the earstem 910. The sliding member 912 connected to the earstem tool 914 may be slid along the sliding aperture 911 by the user in the direction of movement arrow 907. In the example shown, the earstem tool 914 has been extended beyond a posterior end of the earstem 910 so that the plurality of prongs 915 are exposed. In the exposed configuration, the earstem tool 914 may be applied to the task at hand by the user of the eyewear.

Eyewear 100 components such as the earstem 110, 120, 720, 820, 910 and earstem tool 114, 124, 724, 824, 914 may be fabricated using metals, polymers, or other relatively stiff materials. Alternatively, individually or in combination, properties of the eyewear material may provide flexibility and customization for wearer comfort. In some cases, titanium, carbon fiber, plastic, aluminum, rubber, or other construction materials may be used in the eyewear 100 to provide functionality while reducing the weight of the eyewear 100. Rigid materials, such as metals and plastics, may be used to form eyewear 100 having wear resistance, rigidity, and durability. Eyewear 100 may be fabricated from any material, including molded plastic, sheet plastic, acetate, composite, metal, or any combination of these materials.

The versatility of the earstem tool 114, 124, 724, 824, 914 is not limited to the examples shown and may be expressed in other tool types such as a blade, file, saw, opener, ruler, pick, tweezer, pen, or a screwdriver having a slotted, cross-slotted (Phillips), or hexagonal (Allen) shape. While the present disclosure focuses on an earstem tool 114, 124, 724, 824, 914 that is forked into a plurality of prongs, the aforementioned tool types or other tool types may be utilized upon the earstem tool 114, 124, 724, 824, 914, individually, or in combination.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

I claim:

1. Eyewear comprising:
a. an earstem comprising:
i. an earstem tool that is forked into a plurality of prongs.

2. The eyewear of claim 1, wherein the plurality of prongs extend parallel with a longitudinal axis of the earstem.

3. The eyewear of claim 1, wherein the earstem tool comprises at least three prongs.

4. The eyewear of claim 1, further comprising:
a. a retention member mounted on the earstem and structured to release the earstem tool from the earstem.

5. The eyewear of claim 1, further comprising:
a. an aperture within the earstem into which at least a portion of the earstem tool is removably inserted.

6. The eyewear of claim 5, further comprising:
a. a retention member mounted to the earstem and structured to hold the portion of the earstem tool inserted into the earstem.

7. The eyewear of claim 5, wherein at least a portion of the earstem surrounds the earstem tool inserted into the aperture.

8. The eyewear of claim 1, further comprising:
a. a retention member mounted to the earstem and structured to retain the earstem tool upon the earstem.

9. The eyewear of claim 1, wherein the earstem comprising the earstem tool is interchangeable.

10. The eyewear of claim 1, wherein the earstem tool is structured to retract and extend within the earstem.

11. The eyewear of claim 1, further comprising:
a. an aperture within the earstem tool into which at least a portion of the earstem is removably inserted.

12. The eyewear of claim 1, further comprising:
a. a retention member mounted to a frame of the eyewear and structured to retain the earstem upon the frame.

13. The eyewear of claim 1, further comprising:
a. an aperture within the earstem tool into which at least a portion of the earstem is removably inserted.

14. The eyewear of claim 13, wherein at least a portion of the earstem tool surrounds the earstem inserted into the aperture.
